(19) United States
(12) Patent Application Publication
(10) Pub. No.: US 2005/0188015 A1
(43) Pub. Date: Aug. 25, 2005

(54) Communication system

(76) Inventor: Colin William Peter Attwell, Bellville (ZA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/508,660

(22) PCT Filed: Apr. 3, 2003
(86) PCT No.: PCT/ZA03/00044

(30) Foreign Application Priority Data
Apr. 3, 2002 (ZA) 2002/2584

(51) Int. Cl. G06F 15/16

(52) U.S. Cl. 709/205

(57) ABSTRACT

A peer-to-peer communications system comprising a plurality of peers (P, P1, P2 . . . ) connected so that each peer can hear each other peer and speak to each other peer. The peers are numbered and transmission of signals by the peers is sequential and in accordance with the numbering of the peers. Each peer includes means for generating a signal for transmission which signal includes information on the length of the signal. Each peer further includes means for detecting the length of the signal received and, in its turn in the predetermined sequence, initiating its transmission upon detecting that a signal of the length indicated by the length information has been received from the preceding peer in the sequence.

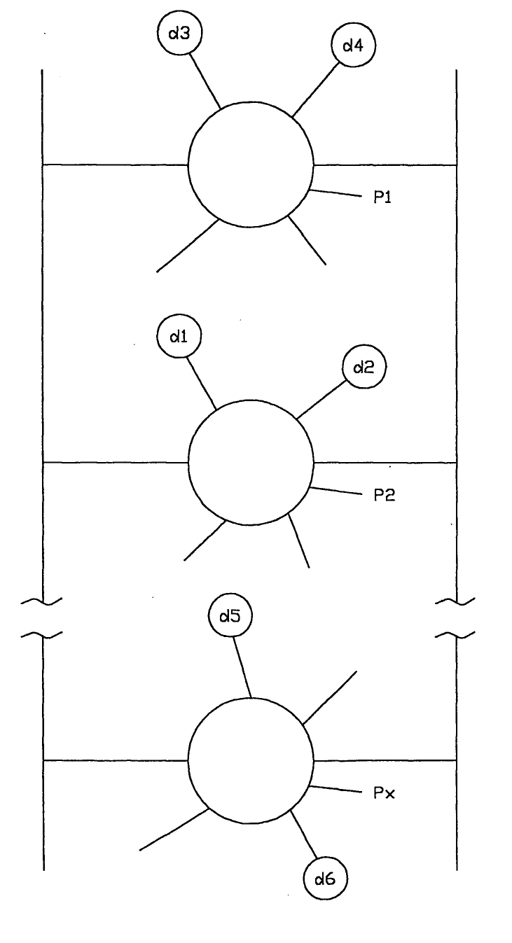

### FIELD OF THE INVENTION

THIS INVENTION relates to communications systems.

### BACKGROUND TO THE INVENTION

One requirement in a node-to-node communications system is that large amounts of information must be transmitted rapidly and without one burst of information being transmitted colliding with another burst of information being transmitted.

In a simple system, one node can be designated as the hub and all the other nodes as slaves which transmit information to, and receive information from, the hub but do not “speak” to or “hear” one another. The transmission of data can thus be considered as constituting “private” conversations between the hub and a specific slave. The transmission is not heard by the other nodes.

In other systems the data is broadcast and is received by all nodes in the system. The software of each receiving node discriminates between data intended for it and data not intended for it.

As soon as the system involves a larger number of nodes, the hub system becomes impractical as the time delays inherent in such a system are not acceptable. This is manifested as slow response times and in some systems is only an irritation. In systems such as fire detection systems it becomes a hazard as it unacceptably delays the reporting of a fire or other event.

The system known as the multi-drop R5485 has been developed to reduce time delays and is a definite improvement over a hub system. All the nodes are in parallel on one pair of wires and the use of time differentials inhibits collisions between data bursts being transmitted. One node is designated as the master node and the others are all slave nodes. All the nodes can hear one another and speak to one another. However, there is still a problem in that the master node polls each slave node in turn and then receives a confirmation signal and the transmission of data. Only when this transmission is complete does the master node poll the next slave node and then await a response and the data. Much time is spent transmitting what are referred as “housekeeping” signals which control the system but do not carry data.

A third system is known as the token ring system. In this the nodes all become peers and the peer with the token is the one that can transmit. By the use of “housekeeping” signals, the token is passed from one node to another whereby each node has a turn at transmitting.

Applicant's experimental work has shown that when the number of nodes reach thirty, forty and upwards, the time delays inherent in these systems are unacceptable, particularly in a fire detection environment.

The object of the present invention is to provide an improved peer-to-peer communication system in which the nodes are equal peers and in which data is transmitted at a faster rate than possible heretofore with a single pair of wires.

### BRIEF DESCRIPTION OF THE INVENTION

According to one aspect of the present invention there is provided a peer-to-peer communications system comprising a plurality of peers in a multi-drop arrangement on a single pair of wires so that each peer can hear each other peer and speak to each other peer, said peers being numbered sequentially and transmission of data by the next peer in the sequence being initiated upon termination of the transmission by the previous peer in the sequence without said next peer being polled to cause it to commence transmission.

According to a further aspect of the present invention there is provided a peer-to-peer communications system comprising a plurality of peers connected in a multi-drop arrangement on a single pair of wires so that each peer can hear each other peer and speak to each other peer, the peers being numbered and transmission of signals by the peers being sequential and in accordance with the numbering of the peers, each peer including means for generating a signal for transmission which signal includes information on the length of the signal, each peer further including means for detecting the length of the signal received and, in its turn in the predetermined sequence, initiating its transmission upon detecting that a signal of the length indicated by said information has been received from the preceding peer in the sequence.

To enable a peer which has a priority message to transmit to interrupt the normal sequence of transmissions which is in accordance with the numbering of the peers, each peer includes means for detecting the end of a transmission and means for transmitting a break message into the gap between the previous transmission and the start of the transmission by the next peer in the normal sequence.

Each peer can include means for detecting the rate at which data is being transmitted on the network, and means for reducing the length of its transmission, or eliminating data transmission by it, in the event that the transmission rate exceeds a predetermined threshold.

Each peer can further include means for logging data transmissions received by it and, in its turn in the transmission sequence, transmitting acknowledgements to the peers from which the data transmissions were received.

Each peer can further include means for creating and transmitting address information whereby each peer determines the peer or peers to which a transmission is directed.

The system of the present invention can further include means for detecting a data collision upon simultaneous transmission by two or more peers, and means for recommencing the data transmission sequence at a predetermined peer.

The system can include means for determining the integrity of a data transmission and also the beginning and end of the data transmission by way of a cyclic redundancy check.

### BRIEF DESCRIPTION OF THE DRAWING

For a better understanding of the present invention, and to show how the same may be carried into effect, reference will now be made, by way of example, to the accompanying drawing in which the single FIGURE diagrammatically illustrates a system in accordance with the present invention.

### DETAILED DESCRIPTION OF THE DRAWING

In a communications system bandwidth is always the factor which limits the amount of useful data which can be transmitted in a given time period. The amount of data which can be transmitted is reduced by the control messages which are essential to running the system, but contain no useful data, and by characters additional to the data characters and which demarcate data fields and validate the data. Quiet periods between transmission of data and any repeated data messages all reduce the bandwidth available for transmission of useful data.

In the single FIGURE of the drawings P1 to Px are all peers. In the specific embodiment being described each peer is a fire panel which receives data from detectors d1, d2. Because there is a physical link between peers, such as a multi-drop, half duplex RS485 over a twisted pair copper cable or other communication link, all peers can hear one another and talk to one another.

At start up the sequence followed establishes the quantity and numbering of peers in the system, each peer being configured with its identifying number and having stored therein the numbers of all peers on the network.

The lowest numbered peer initiates the start up sequence in the system based on a finite delay, which is a multiple of the peer number. Initially each peer transmits only a header block message (as described below) until the entire network has been traversed one or more times. This is to enable all peers to determine whether the expected peers are present or absent.

Each peer, starting with the lowest numbered one, then transmits to all other peers. A message which is devoid of data can, for example, comprise six bytes as follows:

| | | | | | |
|---|---|---|---|---|---|
| 1 | 2 | 3 | 4 | 5 | 6 |

Byte 1 - Peer Number
Byte 2 - Peer Anti number
Bytes 3/4 - Information on signal length
Bytes 5/6 - CCITT polynomial CRC (cyclic redundancy check)

These six bytes constitute a header and, if there is no data to transmit or acknowledgement to be sent, the length of the signal as transmitted in bytes 3 and 4 is the length of the header.

Acknowledgements of data previously received by the peer and data are transmitted immediately after bytes 5 and 6, preferably in the order of acknowledgements and then data. At the end of the data transmission another CCITT polynomial CRC check is made to verify the integrity of the data and acknowledgements transmitted.

The data transmitted by each peer includes the address of the sending peer and the address(es) of the peer or peers which are to receive the data and react to it. This can be contrasted to a simple broadcast system in which the data transmitted is received by all peers, and the software of the receiving peers discriminates between data intended for them and data not intended for them. In accordance with the present invention it is the sending peer which determines which receiving peers must receive and react to the data. Peers do not react to transmissions not addressed to them.

It is an essential requirement of a fire detection system that reception of data sent by one peer to one or more other peers be acknowledged. If it is not acknowledged then, for fail safe purposes, it has to be transmitted again. This can waste bandwidth.

Each peer can receive one or more data transmissions from another peer, or can receive one or more data transmissions from each of two or more other peers. In accordance with the present invention each peer includes means for logging data transmissions received by it and, in its turn in the transmission sequence, transmitting acknowledgements to the peers from which the data transmissions were received.

This can be contrasted to the prior systems known to applicant in which nodes immediately acknowledge data transmissions received by them or only acknowledge when polled by the node which sent the information.

To further enhance the ability of the system to transmit data which is designated high priority data in preference to data which is of low priority, the present invention provides means for load shedding.

The peers in the network are all of equal status and no peer is ever assigned network master status and no peer ever controls the whole network. Each peer is programmed to control its own use of the network in an orderly fashion. As part of this self control a load shedding algorithm is employed. During normal communication each peer transmits data up to the maximum number of characters allowed. In the event that the peer detects that the system is handling transmissions at above a predetermined threshold rate, the load shedding facility reduces, or even terminates, the transmission of low priority data until the transmissions the system is handling drop to below the threshold rate.

In the event that data to be transmitted by a peer is designated high priority, but exceeds the permitted message length, the data transmission can in accordance with the present invention include information to the effect that there is more high priority information to be transmitted. Receipt by other peers to this transmission causes the other peers to withhold transmission of data of lower priority but to transmit acknowledgements and data of the same or higher priority.

This situation will prevail until the peer with high priority data to transmit has cleared its message storage buffer.

The communications system also includes the facility for a peer to interrupt the normal data transmission sequence by inserting a break signal into the network.

At the end of the transmission by any peer, whether the transmission be a header or a header plus acknowledgements or a header plus acknowledgements plus data, there is a period of silence to permit the RS485 line to settle to a floating state. This period can be, for example, 20 milliseconds.

At the end of this period the next peer would normally commence transmitting. However, the insertion of a break signal into this quiet time by any peer causes all other peers to enter a “back-off” mode during which their ability to transmit is blocked. Once the high priority message has been transmitted the normal sequence recommences, starting with the next peer in the sequence from the one which transmitted the break signal.

It will be understood that except in the circumstances just discussed no peer should start transmitting until the end of the quiet period, and then only in its sequence, and no peer should transmit whilst it is detecting a transmission emanating from another peer.

However, the system must be able to deal with a situation where two transmissions do occur simultaneously, this resulting in corrupted data being received by the peers, As no peer receives an intelligible transmission, there is a failure in the sequence and no peer is switched to its transmission mode. This has the effect of “re-setting” the system so that the first peer in the sequence commences to transmit following a detected data collision.

Enabling a peer to log received transmissions and then send, in its turn in the sequence, all necessary acknowledgements to the peers from which transmissions were received, reduces the number of transmissions that are necessary. However, it will be understood that each peer acts on a received transmission immediately even though its acknowledgement may be delayed due to its position in the sequence vis-a-vis the sending peer.

1. A peer-to-peer communications system comprising a plurality of peers in series on a single pair of wires so that each peer can hear each other peer and speak to each other peer, said peers being numbered sequentially and transmission of data by the next peer in the sequence being initiated upon termination of the transmission by the previous peer in the sequence without said next peer being polled.

2. A peer-to-peer communications system comprising a plurality of peers connected in series so that each peer can hear each other peer and speak to each other peer, the peers being numbered and transmission of signals by the peers being sequential and in accordance with the numbering of the peers, each peer including means for generating a signal for transmission which signal includes information on the length of the signal and each peer further including means for detecting the length of the signal received and, in its turn in the predetermined sequence, initiating its transmission upon detecting that a signal of the length indicated by said information has been received from the preceding peer in the sequence.

3. A system in claim 1, wherein each peer includes means for detecting the ends of a transmission and means for transmitting a break message into the gap between the previous transmission and the start of the transmission by the next peer in the normal sequence.

4. A system as in claim 1, wherein each peer includes means for detecting the rate at which data is being transmitted on the network, and means for reducing the length of its transmission, or eliminating data transmission by it, in the event that the transmission rate exceeds a predetermined threshold.

5. A system in claim 1, wherein each peer further includes means for logging data transmissions received by it and, in its turn in the transmission sequence, transmitting acknowledgments to the peers from which the data transmissions were received.

6. A system as in claim 1, wherein each peer includes means for creating and transmitting address information whereby each peer determines the peer or peers to which a transmission is directed.

7. A system as in claim 1, and including means for detecting a data collision upon simultaneous transmission by two or more peers, and means for recommencing the data transmission sequence at a predetermined peer.

8. A system as in claim 1 and including means for determining the integrity of a data transmission and also the beginning and end of the data transmission by way of the cyclic redundancy check.
